(19) United States
(12) Patent Application Publication
(10) Pub. No.: US 2007/0261726 A1
(43) Pub. Date: Nov. 15, 2007

(54) MULTIPLE WORKPIECE PROCESSOR

(76) Inventors: Jason A. Rye, Kalispell, MT (US); Kyle M. Hanson, Kalispell, MT (US)

Correspondence Address: PERKINS COIE LLP/SEMITOOL, PO BOX 1208, SEATTLE, WA, 98111-1208, US

(21) Appl. No.: 11/382,893

(22) Filed: May 11, 2006

(51) Int. Cl. B08B 3/00

(52) U.S. Cl. 134/157; 134/95.2

(57) ABSTRACT

A wafer processor has a process head engageable with a process chamber. A rotor on the process head has multiple wafer holding positions offset from the rotor axis. A wafer retaining device holds the wafers in place, in the holding positions, during processing. As the rotor spins, wafers retained in the wafer holding positions revolve around the axis. Multiple smaller size wafers may be simultaneously processed within a single processor.

### BACKGROUND OF THE INVENTION

Semiconductor devices and similar micro-scale devices are generally manufactured from flat, round wafers. Many different steps are used in manufacturing these types of devices. In certain steps, liquid process chemicals are sprayed onto one or more spinning wafers. Various spin/spray workpiece processors have been used for this purpose.

Currently, standard commonly used wafers are 150 mm, 200 mm or 300 mm in diameter. In single wafer processing, spin/spray processors process these types of wafers one at a time, with a single wafer supported concentrically on a rotor. The rotor spins the workpiece, while process liquids are sprayed or otherwise applied onto the rotating workpiece. Throughput (the number of wafers processed per hour) with these types of single wafer spin/spray processors may be relatively low, since only one wafer is processed at a time. However, manufacturing yield, (the number of devices manufactured per wafer) is reasonable, because hundreds or thousands of devices may be created from a single wafer.

The trend in the semiconductor device industry has been to move toward larger diameter wafers, to improve manufacturing efficiencies. For example, while 150 mm or 200 mm wafers may have been the industry standard for much of the last decade, 300 mm diameter wafers are now becoming the new industry standard. However, contrary to the trend towards use of ever larger wafers, for some specialized types of devices, small wafer sizes have been adopted. For example, two-inch (50 mm) and three-inch (75 mm) wafers have recently come into more widespread use for manufacturing LED's.

The number of devices which may be manufactured on a wafer (i.e., the yield per wafer) is proportional to the surface area of the wafer. Accordingly, the yield per wafer of these smaller diameter wafers is low in comparison to the larger wafers. For example, the yield per wafer for a 50 mm wafer is 1/9 of a 150 mm wafer, and 1/36 of a 300 mm wafer. Accordingly, use of existing spin/spray processors with smaller size wafers is slow and not efficient. Hence, new processors and methods are needed to provide faster and more efficient processing of small size wafers.

Small size wafers, for example, 50 mm and 75 mm wafers, are also generally much thinner than larger wafers. Accordingly, they are more fragile than larger wafers. As a result, use of equipment and methods intended for larger size wafers with smaller size wafers, can result in more wafers being broken and lost during manufacturing. Accordingly, improved processors and methods better able to handle more fragile wafers are needed.

### SUMMARY OF THE INVENTION

A new processor has now been invented which provides great improvements in processing of smaller wafers. With this new processor, multiple wafers may be simultaneously processed. Consequently, greater number of devices may be manufactured in less time, and using less process chemicals and water. This new processor also can process thin wafers, with less risk of damage to them.

In one aspect, the workpiece processor has a process head which cooperates with a process chamber. A rotor is supported on or in the process head. The rotor has two or more workpiece or wafer holding positions offset from the rotor axis of rotation. As the rotor rotates, the workpieces revolve around the axis of rotation. A process fluid outlet in the chamber applies process fluid onto the revolving workpieces. One or more spray nozzles may be used as a process fluid outlet. The spray nozzles may optionally be positioned on a swing arm in the process chamber.

Workpiece holders on the rotor, and one or more workpiece retainers, may be used to securely support and hold the workpieces in place during processing, and also allow for loading and unloading of workpieces.

Various other features are shown and described in the drawings, which show representative examples of processors according to the invention. The drawings, however, are not intended to show all of the ways that the invention may be constructed and used, and the drawings are not intended as limitations on the invention.

### BRIEF DESCRIPTION OF THE DRAWINGS

In the drawings, wherein the same reference number indicates the same element in each of the views:

FIG. 1 is a top and side perspective view of a workpiece processor.

FIG. 2 is a section view of the processor shown in FIG. 1.

FIG. 3 is an enlarged section view.

FIG. 4 is a top perspective view of the rotor shown in FIGS. 2 and 3.

FIG. 5 is a bottom view of the rotor shown in FIG. 4.

FIG. 6 is a bottom view of an alternative rotor.

FIG. 7 is a top view of the rotor shown in FIG. 4.

FIG. 8 is a section view taken along line 8-8 of FIG. 7.

FIG. 9 is an inverted perspective view of the rotor shown in FIGS. 2-5 and 7-8, with the rotor shown in an open or load/unload position.

FIG. 10 is a perspective view of the rotor of FIG. 9, with the rotor in a closed or process position.

FIG. 11 is a perspective view of the retainer plate shown in FIGS. 8-10.

FIG. 12 is a section view taken along line 12-12 of FIG. 11.

FIG. 13 is an enlarged detail view of the circled in area of FIG. 12.

FIG. 14 is a plan view of a processing system having one or more of the processors shown in FIGS. 2-3.

FIG. 15 is a side view of the processing system shown in FIG. 11.

### DETAILED DESCRIPTION OF THE DRAWINGS

An apparatus and method for holding two or more wafers in a rotor are described. The workpieces are offset from the rotor axis and revolve around the rotor axis. Since each processor can simultaneously process multiple wafers, manufacturing efficiency is improved. A wafer retainer is provided with the rotor for holding the wafers in place during processing. The wafer retainer may be moved to a position allowing wafers to be loaded into and unloaded from the rotor, either manually or via robot. Wafer holders on the rotor may provide a backing surface to support the wafers during high pressure processing where liquid streams or sprays impact on the wafers.

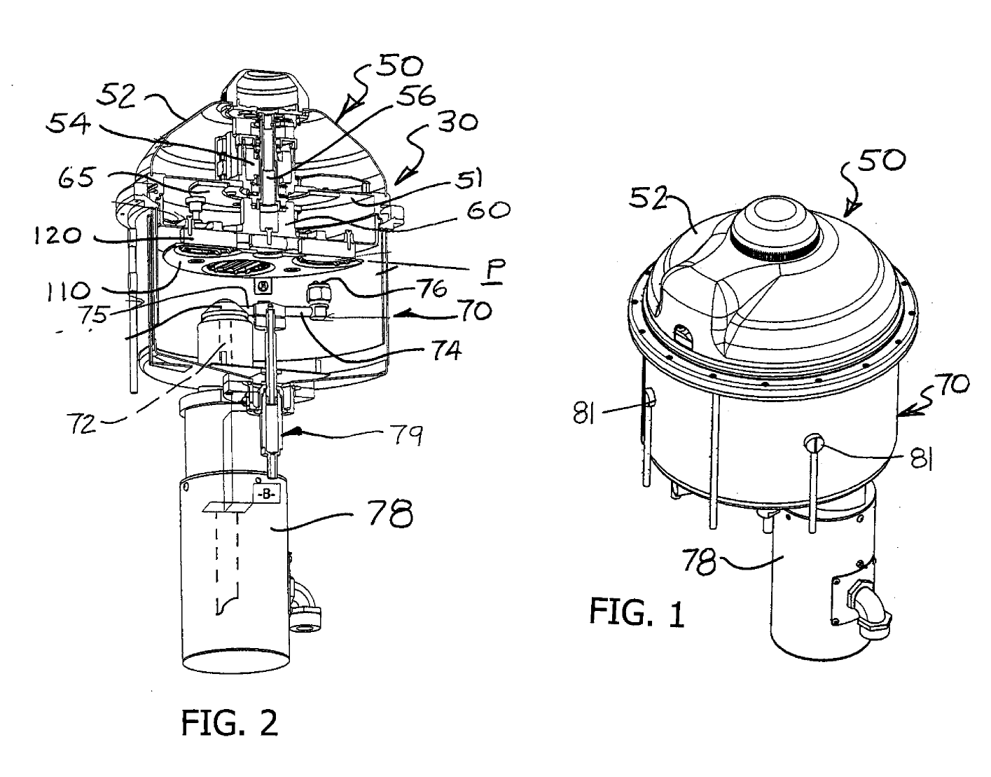

As shown in FIGS. 1-3, a processor 30 has a head 50 that may be moved into engagement with a process chamber 70. A motor 54 may be provided in the head 50 to rotate a shaft 56 of a rotor 60. The shaft 56 may be supported on a head plate 51 or similar structure by the motor or one or more bearings 55. A housing 52 on the head plate 51 encloses the motor 54 and other head components.

A lift arm 62 attached to the head plate 51 is linked to a lift apparatus for moving the head 50 into engagement with the process chamber 70, for processing, or for lifting the head 50 away from the process chamber 70, for loading and unloading wafers into the head 50. Alternatively a lift/rotate apparatus may be used, to also pivot the head 50 into an upside down position, for loading and unloading, or for further processing above the process chamber.

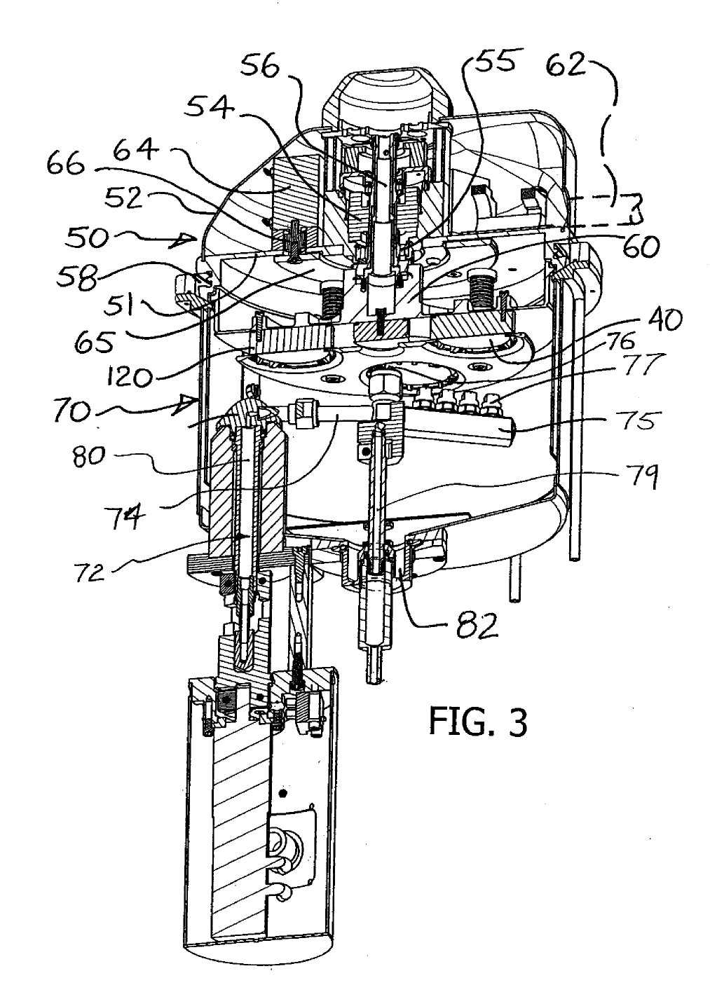

As shown in FIG. 3, a seal 58 adjacent to a top edge of the process chamber 70 may be used to contain process liquids, gasses, or vapors within the process chamber 70 during processing. The lower edge of the head plate 51 may be adapted to contact the seal 58, to form a closed environment within the process chamber 70 when the head 50 is engaged with the process chamber 70. Alternatively, the head may be spaced apart from the process chamber 70 during processing, with an air gap between them.

Referring still to FIG. 3, actuators 64 are attached on the top surface of the head plate 51. An actuator ring 65 is supported below the head plate 51 on plungers 66 extending through clearance openings in the head plate 51. Energizing the actuators 64 can drive the actuator ring 65 up and down.

Referring to FIGS. 2 and 3, various types of process fluid delivery systems 72 may be used with the process chamber 70. In the design shown, the process fluid delivery system 72 includes high pressure spray nozzles 76 on a swing arm 74. In this case, a swing arm motor 78 drives the swing arm 74 in a back and forth movement within the process chamber 70. A fixed spray manifold 75 having low pressure spray nozzles 77 supplied via a second fluid delivery system 79, may also be used. In addition, fixed side spray nozzles 81 may be provided on the chamber sidewalls, as shown in FIG. 1.

As shown in FIG. 3, a fluid supply line 80 supplies process fluid to the nozzles 76 on the swing arm 74. A second swing arm may also be used. Additional fixed process fluid outlets or nozzles may be provided on or in the sidewalls of the process chamber 70, and/or at the bottom of the process chamber 70. The nozzles 76 or other process fluid outlets may be provided individually, or on manifolds. A drain 82 may be located at a low point of the process chamber 70, to better collect used process liquids via gravity and/or gas flow.

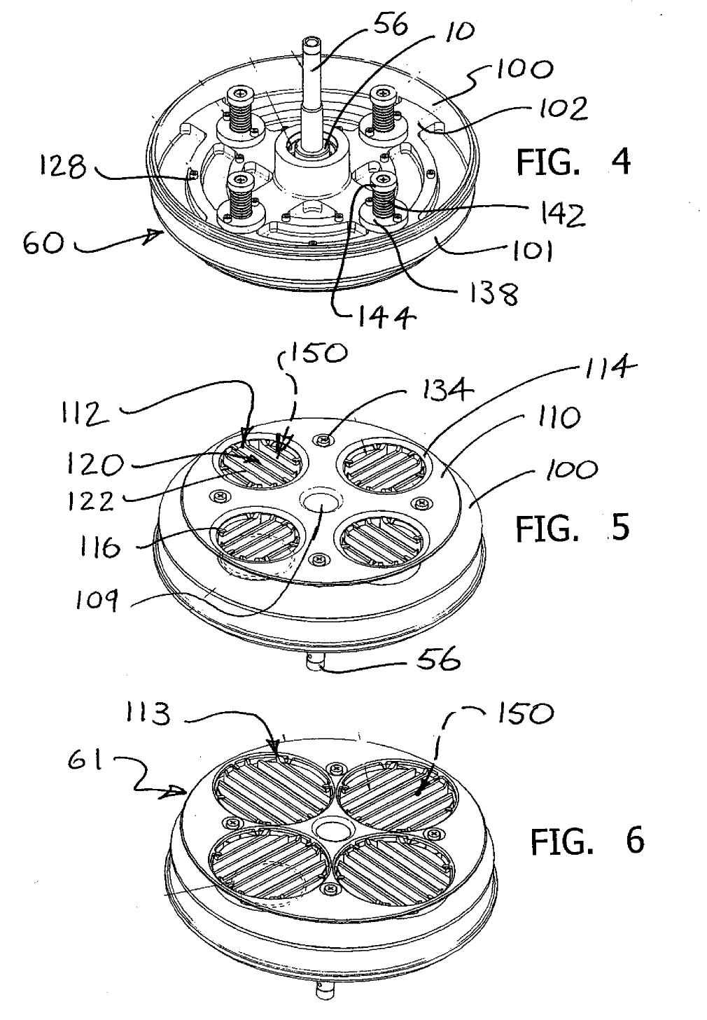

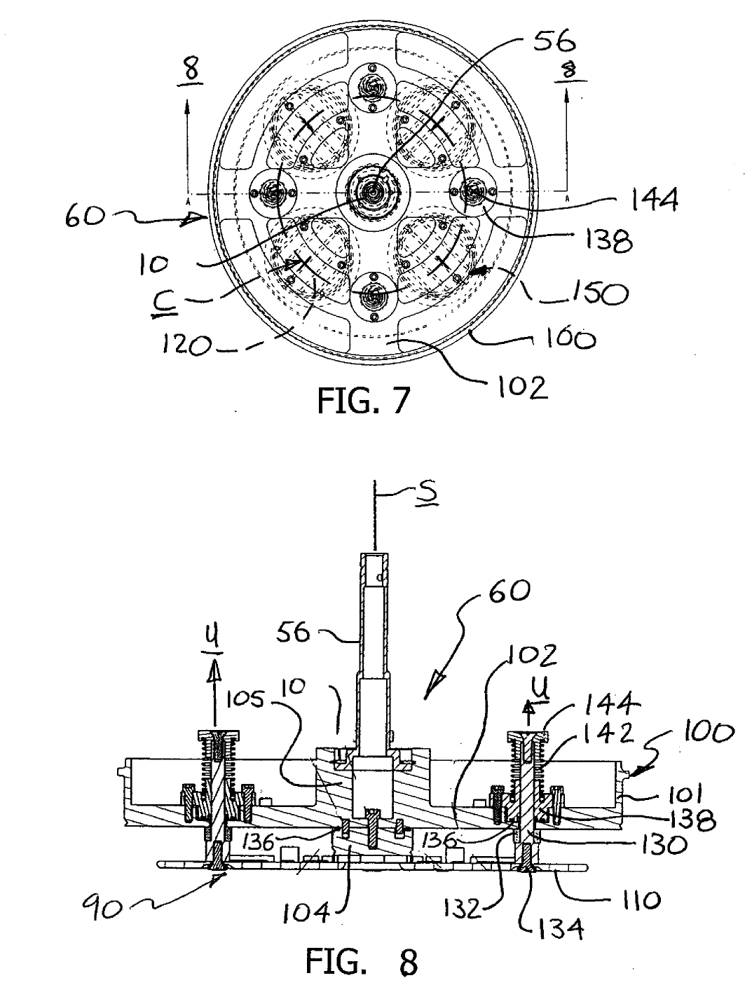

Turning now to FIGS. 4, 5, 7, 8, and 9, the rotor 60 may have a drive plate 100 including a web section 102 and a side wall 101. A hub 105 at the center of the web section 102 is attached to the shaft 56. As shown in FIGS. 5 and 7, the rotor 60 includes multiple wafer holding positions 150. In the design shown, four wafer holding positions 150 are used, although the rotor may be designed with 2, 3, 4, 5, 6, 7, 8, 9, 10 or more positions. As shown in FIG. 7, the center of each wafer holding position 150 may be aligned on a circle C, typically co-axial with the spin axis S of the rotor 60. This symmetrical arrangement may provide for better rotor balance and more uniform processing. However, other designs may be used, for example with non-aligned or non-symmetrical wafer holding positions.

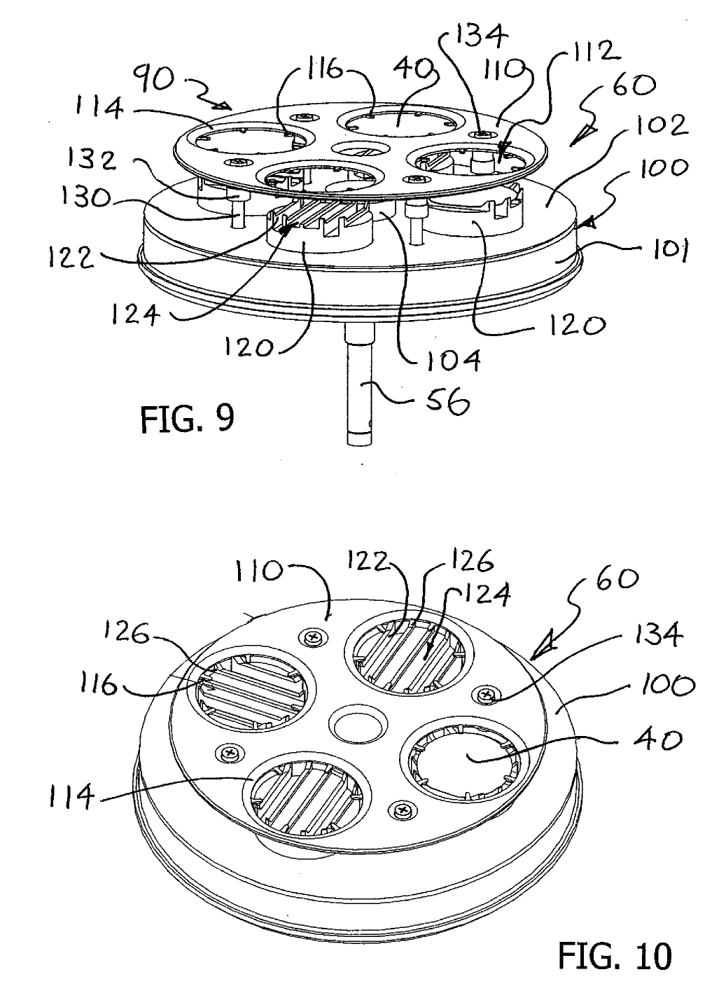

The wafer holding positions 150 may be formed in various ways. One way of providing the wafer holding positions 150 is shown in FIG. 9. The wafer holding positions 150 in FIG. 9 are formed by wafer holders or chucks 120 attached to the drive plate 100. In this design, the wafer holders 120 are attached to the rotor 60 via cap screws 128 in the web section 102, as shown in FIG. 4. A wafer holder 120 may include raised ribs 122 spaced apart by grooves or slots 124, as shown in FIG. 9. Angled sections or ramps 126 may be provided at the ends of the ribs 122. Some of the slots 124, such as the outer slots, may be deeper than other slots, such as the inner slots, on the wafer holder 120. The ribs 122 and slots 124 may be parallel to each other, with the wafer holder 120 oriented so that a rib 122 or a slot 124 is substantially parallel to a radius of the rotor 60 extending outwardly from the axis of rotation S. As shown in FIG. 9, the wafer holders 120 may all be positioned so that all of the wafers held on the rotor 60 are held substantially in the same horizontal plane. FIG. 9 shows the rotor 60 upside down, for purpose of illustration. In most applications, the rotor 60 operates in a processor 30 in a right-side up orientation, with the shaft 56 extending upwardly, and with the wafer holding positions 150 face down, as shown in FIGS. 2 and 3. However, a processor 30 having the rotor 60 may also operate with the wafer holding positions 150 face up, as shown in FIGS. 5, 6, 9, and 10.

A wafer retaining system or device 90 is associated with the rotor 60. The wafer retaining system 90 retains or holds the wafers in place in the wafer holding positions 120 on the rotor 60. In the specific example shown in the drawings, the wafer retaining system 90 holds the wafers in place on or in the wafer holders 120. An example of a wafer retaining system 90 is shown in FIGS. 8, 9, and 10. In this example, the wafer retaining system 90 includes a retainer plate 110 having through openings 112 aligned over the wafer holding positions 150. The retainer plate 110 is attached to push rods 130 with fasteners 134. As shown in FIG. 8, the push rods 130 extend through openings in the Web section 101 of the drive plate 100. The push rods 130 are supported by collars 138 on the drive plate 100. A spring 142 around the push rod is retained by a cap 144. The spring 142 pushes the push rod 130 upwardly (in the direction of the arrow U in FIG. 8). Spacers 132 around the lower end of each push rod 130 maintain a minimum distance between the retainer plate 110 and the lower surface of the web section 102 of the drive plate 100. A diffuser 104 may optionally be attached to the drive plate 100, as shown in FIG. 8. The diffuser 104 and the collars 138 may be sealed against the drive plate 100 using O-rings 136, to prevent or reduce movement of process fluids into the head 50.

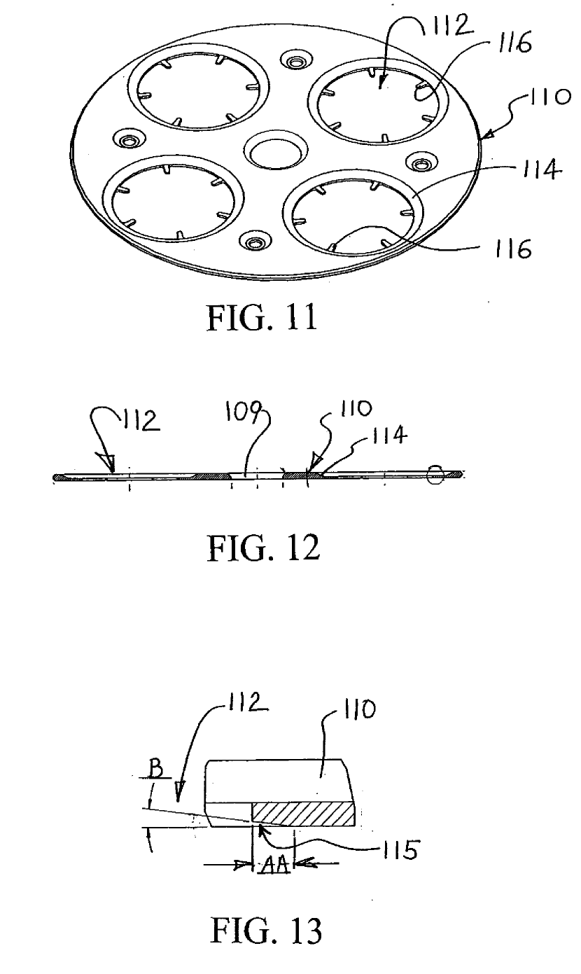

As shown in FIGS. 5, 9-12, tabs or fingers 116 extend radially inwardly at the openings 112 through the retainer plate 110. A bevel or angled annular surface 114 at each of the openings 112 extends up from the bottom surface (the surface facing the process chamber 70 in FIGS. 2 and 3) of the retainer plate 110. The angled surface 114 helps process liquids flow smoothly off of the plate 110. As shown in FIG. 13, an angled annular surface 115 may also be provided at each of the openings 112 on the top surface (the surface facing the wafer) of the retainer plate 110. The angled surface 115 helps to avoid droplets of liquid adhering to the retainer plate 110, which can cause wafers to stick to the retainer plate 110. The angle B in FIG. 13 may typically range from about 3-12, 5-9, or 6-8 degrees with dimension AA similarly ranging from about 1-3 mm.

The wafer retainer system described above is an example of various equivalent wafer retainer systems that may be used. For example, multiple individual or separate retaining plates, rings, or elements may be used. Similarly the fingers 116 may be replaced by point contacts, slots, or other holding elements. The push rods 130, springs 142, fingers 116, and other associated components may be entirely omitted and replaced with other forms of holding elements. Other wafer retaining systems may use vacuum, electrostatic holding, fluid flow/Bernoulli effects, or other non-mechanical or mechanical elements. The specific wafer retainer system selected may vary based on multiple factors.

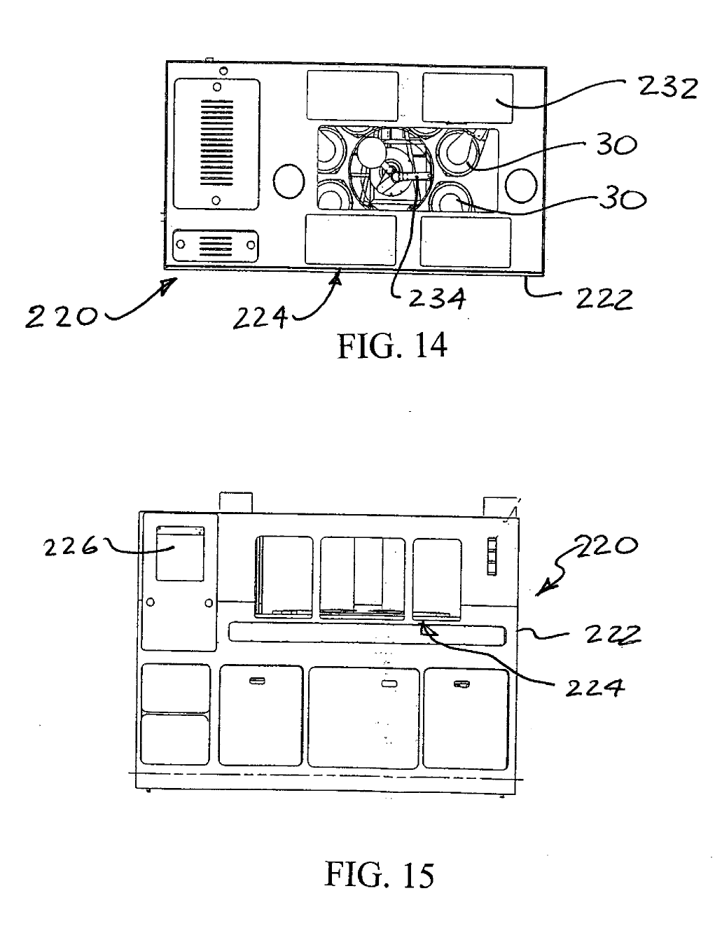

The processor 30 may be used separately, or it may be provided in an automated processing system. An example of an automated processing system 220 is shown in FIGS. 14 and 15.

This processing system 220 has multiple processors 30 within an enclosure 222. Wafers are moved into and out of the processing system 220 via a load/unload port or window 224 in the enclosure 222, A control panel 226, and an electronic controller, may be provided with the processing system 220 to control and monitor processing system status and operations. Temporary storage or work in progress positions 232 may be provided within the enclosure 222. One or more robots 234 move wafers within the processing system 220.

In use, the processor 30, either within a processing system such as the system 220 shown in FIGS. 14 and 15, or operating as a stand-alone unit, is loaded with wafers 40. The head 50 is lifted away from the process chamber 70 and may also be turned upside down. In this case, a lifter lifts the head lift arm 62, and then rotates the lift arm 62 one-half turn, so that the head is face up. The linear actuators 64 are turned on, driving the actuator ring 65 against the caps 144 of the wafer retaining system 90. This moves the retainer plate 110 up and away from the drive plate 100 and the wafer holders 120 into the position shown in FIG. 9.

Wafers 40 are then loaded onto the wafer holders 120, typically by a robot. The rotor 60 may be indexed, i.e., rotated ¼ turn, to sequentially move each wafer holder 120 into a load position. During loading, a wafer 40 is lowered by the robot (not shown), or optionally by hand onto a wafer holder 120. The ramps 126 at the ends of the ribs 122 help to center the wafer on the wafer holder 120. When loaded, the wafer 40 rests on the top surfaces of the ribs 120, with the circumferential edge of the wafer adjacent to, or in contact with, one or more of the ramps 126. The wafers 40 may remain on the wafer holders 120 via gravity.

After the rotor 60 is loaded with wafers 40, the actuators 64 in the head 50 are reversed or released. Referring momentarily to FIG. 9, the springs 142 pull the retainer plate 110 down. Referring also now to FIG. 8, the retainer plate 110 moves down (towards the wafer holders 120) until it comes to a hard stop provided by the spacers 132 and/or the diffuser 104. With the wafer retaining system 90 now engaged to retain the wafers, the fingers 116 at the bottom surface of the retainer plate 110 are positioned nominally above (e.g., 0-0.5 mm or 0.1-0.2 mm) the wafer 40. Consequently, the wafer 40 is caged in place in the wafer holder 120.

FIGS. 2-5 and 7-10 show a rotor 60 for processing 50 mm (two-inch diameter) wafers. These wafers tend to be thin, e.g., about 0.2-0.5 mm, and relatively fragile. Accordingly, the wafer retaining system 90 is designed to securely retain each wafer 40 in position, while also applying virtually no force to the wafer. As shown in FIG. 10, multiple fingers 116 (in this case 6) are used, with the fingers roughly equally spaced apart. In addition, the fingers 116 may be located at locations over a rib 122 (in designs where the fingers make actual contact with the wafer). FIG. 6 shows an alternative rotor 61 for holding 75 mm (three-inch diameter) wafers. The other features of the rotor 61 may be the same at the rotor 60, as described above. As is apparent by comparing the rotor 60 in FIG. 5 with the rotor 61 in FIG. 6, various other arrangements and numbers of wafer holding positions 150 may be used, depending on the size and/or shape of the wafer 40, and the diameter of the rotor.

Referring to FIGS. 2 and 3, with the rotor 60 loaded with wafers 40, and with the wafer retaining system 90 retaining the wafers 40 in or on the wafer holders 120, the head 50 is rotated back one-half turn, so that the head is once again right side up (and the wafers 40 are facing down). For processors designed for loading/unloading in a face down position, the one-half rotation step is not used. The head 50 is then moved into engagement with the process chamber 70, and optionally sealing with the process chamber 70. When the head 50 is engaged with the process chamber 70, the head 50 will generally be in physical contact with the process chamber 70. However, in some applications, the head 50 may also be spaced apart, at least slightly, from the process chamber 70. Accordingly, the term “engaged” here means positioned to cooperate with, and not necessarily in physical contact with, the process chamber. The specific type of process chamber used is not important. Indeed, the head and rotor 60 may be used without any process chamber.

During typical processing, the motor 54 is then turned on rotating the rotor 60 within the process chamber 70. Process fluids are then sprayed or otherwise applied onto the revolving wafers 40 via the nozzles 76, and/or other outlets. The term “revolving” here means that the wafers are moving in a circle or orbiting around the spin axis. The processor 30 may perform high pressure processing to remove metals from the down-facing side of the wafers. In this process, a metal etchant liquid, which may be optionally heated, is sprayed or jetted upwardly against the revolving wafers 40 at high pressure, such as 500-2000, 1000-1400, or about 1200 psi. Fixed or moving spray nozzles or outlets may be used. Regardless of the way the process liquid is applied, each of the wafers 40 receives substantially the same exposure to the process liquid, since the wafers 40 revolve in a single plane (designated P in FIG. 2).

Since the wafers are very thin and fragile, they are advantageously supported against the impact of the high pressure liquid spray or jet. At the same time however, all surfaces of the wafer should also be unobstructed, so that the process liquids contact all areas of the wafer. The wafers should also be supported in a way that allows for effective removal of liquid, so that they may be dried after processing. The novel wafer holders and retainer system achieve these objectives. The ribs 122 on the wafer holders 120 support the wafers 40 against any impact of the process liquid. The wafer retaining system 90, in this case, specifically, the wafer holders 120 and the retainer plate 110 including the fingers 116, retain or cage the wafers 40 sufficiently to minimize movement of the wafers. Process liquids are able to contact all areas of the down facing surface, since the fingers do not clamp down on the wafer. Process and/or rinsing liquids are able to contact virtually all areas of the back or upfacing surface of the wafer, as the wafer can lift off of the ribs of the wafer holders. The slots or grooves 124 on the wafer holders 120 allow for circulation of air on the back side of the wafers, during drying. The specific process fluids used, and the sequence, timing, temperatures, and other process parameters, may of course vary with the specific use.

Air or other inert gas flow may be provided downwardly through the head 50 and out of the process chamber 70 via a gas exhaust, to reduce migration of process fluids into the head 50. Used process liquids may be collected at the drain 82, and removed from the process chamber 70. After completion of chemical processing, a rinse liquid, such as Dl water may be applied to the wafers 40, and optionally to chamber or rotor surfaces, to remove any remaining process fluids. The diffuser 104 may diffuse or disperse a rinsing liquid onto the back (up facing) sides of the wafers 40, with the rinsing liquid provided through hole 109. The wafers 40 may then be dried by continuing to spin the rotor, optionally at higher speeds.

After processing of the wafers 40 is complete, including any rinsing and drying steps, the head 50 is lifted from the process chamber 70 and once again inverted, for unloading. With the head inverted, the actuators 64 are once again turned on to drive the retainer plate 110 up and away from the wafer holders 120, thereby releasing the wafer retaining system 90, as shown in FIG. 9. The processed wafers 40 may then be removed from the head 50, using the reverse sequence of steps described above, and unprocessed wafers 40 similarly then loaded into the head 50 as described above.

The processor 60 is useful for processing various articles. Accordingly, the term wafer or workpiece as used here means semiconductor wafers, flat panel displays, hard disk media, CD glass, memory and optical media, MEMS devices, and various other substrates on which micro-electronic, micro-mechanical, or micro-electromechanical devices are or can be formed. These are collectively referred to here as “workpieces” or “wafers.” While the processor 30 is especially useful with smaller wafers, e.g., 50 mm and 75 mm diameter, it may of course also be scaled up for processing larger wafers, such as 150 mm or 200 mm diameter wafers. Similarly, while the processor 30 is especially useful with thin wafers, (e.g., wafers from about 0.1 mm to about 0.6 or 0.8 mm), it may also be used for processing thicker workpieces. The processor 30 may also be adapted for applications using face down loading/unloading. In these applications, the wafer holders 120 or equivalent components may be located on a vertically displaceable element, such as the retainer plate, with fingers such as finger 116 or other holding elements, on the drive plate. Regardless of the loading/unloading orientation, the processor may optionally be provided with a wafer retaining system having no moving parts, especially with manual operations.

Thus, a novel processor system and corresponding methods have been shown and described. Various changes and substitutions may of course be made without departing from the spirit and scope of the invention. The invention, therefore, should not be limited, except to the following claims and their equivalents.

1. A workpiece processor, comprising:
a process chamber;
a process head engageable with the process chamber;
a rotor supported by the process head, and rotatable about a rotation axis relative to the process head;
with the rotor having at least two workpiece positions adapted for holding a workpiece, and with the process positions spaced apart from the rotation axis.

2. The workpiece processor of claim 1 wherein the process head is engageable with the process chamber by making physical contact with the process chamber.

3. The workpiece processor of claim 1 wherein the rotor has four workpiece positions spaced radially outwardly from the rotation axis of the rotor.

4. The workpiece processor of claim 1 further comprising a plate on the rotor having an opening at each workpiece position, and with the opening substantially equal to a diameter of a workpiece.

5. The workpiece processor of claim 1 further comprising a plate on the rotor with the plate having an opening at each workpiece position, and with a plurality of retainer fingers extending radially inwardly at each opening.

6. The workpiece processor of claim 1 further comprising a plate on the rotor with the plate having an opening at each workpiece position, and one or more spring elements urging the plate towards the rotor.

7. The workpiece processor of claim 1 further comprising a workpiece chuck attached to the rotor at each workpiece position.

8. The workpiece processor of claim 7 with each wafer chuck having a plurality of parallel ribs.

9. The workpiece processor of claim 1 with substantially each of the workpiece positions located in a single plane.

10. A workpiece processor, comprising:
a process chamber;
a process head associated with the process chamber;
a rotor supported on the process head;
rotation means for rotating the rotor about a rotation axis; and
holding means for holding at least two workpieces on the rotor at positions offset from the rotor axis.

11. A workpiece processor comprising:
a chamber;
a head moveable into a process position relative to the chamber;
with the head having a rotor, and with the rotor including a plurality of workpiece holders positioned radially outwardly from a rotation axis of the rotor; and
at least one workpiece retainer associated with substantially each workpiece holder.

12. The workpiece processor of claim 11 wherein the workpiece retainer comprises a retainer plate having an opening aligned with substantially each workpiece holder, and with the retainer plate moveable from a closed position, wherein the retainer plate is adjacent to or in contact with one or more of the workpiece holders, to an open position, wherein the retainer plate is spaced apart from the workpiece holders.

13. The workpiece processor of claim 11 further comprising a process fluid outlet in the chamber, and with the workpiece holders sequentially moveable into a position aligned with the process fluid outlet, by rotating the rotor.

14. The workpiece processor of claim 13 with the process fluid outlet comprising one or more spray nozzles moveable within the chamber.

15. The workpiece processor of claim 13 with substantially each of the workpiece holders spaced apart from the process fluid outlet by substantially the same vertical dimension.

16. The workpiece processor of claim 13 wherein as the rotor rotates, each of the workpiece holders is sequentially moved into a position spaced apart from the process fluid outlet by a dimension D.

17. The workpiece processor of claim 13 wherein the workpiece holders are positioned symmetrically on the rotor.

18. A workpiece processing system, comprising:
a plurality of processors, with at least one of the processors having:
a process chamber;
a process head engageable;
a rotor supported by the process head, and rotatable about a rotation axis relative to the process head, and with the rotor having at least two workpiece positions adapted for holding a workpiece, and with the process positions spaced apart from the rotation axis; and
a robot movable between the plurality or processors.

19. A workpiece processor, comprising:
a process chamber;
a rotor associated with the process chamber;
with the rotor having holding means for simultaneously holding a plurality or workpieces at positions centered off of a rotation axis of the rotor, and for revolving the workpieces in substantially a single plane about the rotation axis.

20. The workpiece processor of claim 19 with the holding means comprising a plurality of workpiece holders on the rotor and a retainer plate on the rotor, with the retainer plate moveable in a direction parallel to the rotation axis, between load/unload and process positions.
